(19) United States
(12) Patent Application Publication
(10) Pub. No.: US 2004/0011632 A1
(43) Pub. Date: Jan. 22, 2004

(54) Safety switch device for a rotary powered hand tool

(76) Inventors: Peter Hellmann, Obermeitingen (DE); Claus Osselmann, Kaltenberg (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 09/981,520

(22) Filed: Oct. 17, 2001

(30) Foreign Application Priority Data
Oct. 19, 2000 (DE) 10051775.7

(51) Int. Cl. H01H 67/26

(52) U.S. Cl. 200/179

(57) ABSTRACT

A safety switch device (6) for the generation of a control signal (Θ) when the future angle of deflection of the housing of a rotary electrically powered hand tool exceeds a predetermined value, wherein a rotational rate sensor (7) directly measuring the rotational velocity (ω) is connected to a comparison element (8) in a signal-transferring fashion.

### BACKGROUND OF THE INVENTION

The invention relates to a safety switch device, preferably, for a partially rotating electrically powered hand tool, such as a drill or a hammer drill. The power flux from the electrical drive to the main spindle of the tool is interrupted by safety release couplings to avoid unwanted torsion stressing on the hand grip of the housing caused, for example, by tool blockage.

DE43334933A1 discloses a rotary powered hand tool wherein the vibration is measured diagonally to the axis of rotation using an acceleration sensor and monitored for a predetermined time interval. The power flux from the electrical drive to the main spindle is sensor-controlled and interrupted if during the time interval a zero crossing does not occur. Such a zero crossing is required and consequently characteristic for stable angular orientation to the axis of rotation. High rotational accelerations are not recognized within the limits of the time interval.

DE4334933A1 discloses that the rotational acceleration is measured using a rotational acceleration sensor and calculated for a predetermined future time interval according to an analog or digital integration, in a limited frequency band, of a future angle of deflection of the housing, which results in the disconnection or interruption of the power flux when such angle exceeds a critical value.

U.S. Pat. No. 5,247,252 discloses the general measuring, of a piezoceramic rotational rate sensor, on the basis of Coriolis forces, which is used for the determination of the rotational velocity.

### SUMMARY OF THE INVENTION

The object of the present invention is to provide for the reduction of required components of a safety switch device based on the future angle of deflection relating to the interruption or disconnection of the power flux of the hand tool, in the event of tool blockage.

The object of the invention is essentially achieved by a safety switch device for the generation of a control signal when a future angle of deflection of the housing of an at least partially rotary powered hand tool is exceeded. Essentially, a rotational rate sensor directly measuring rotational velocity and a comparison element are connected together for the production of a control signal for the interruption of at least the power flow and the current path of a rotary powered hand tool. The comparison element is connected to the sensor output and compares the measured value to a threshold value, the value being at least partially proportional to the rotational velocity.

In electrically powered rotary hand tools, using approximately a constant rotational acceleration through the inertial mass of the components of the drive train during the short future time interval of 1 ms to 100 ms preferably approximately 20 ms, the angle of rotation, for simplicity is set to zero at the start of the time interval, and is calculated, in accordance with the linear motion equation for even, steady state, rotational movements by approximate proportion to the directly measured rotational velocity, whereby one term containing an integration of a rotational acceleration, need not be realized in the functional unit.

The rotational rate sensor is, preferably, constructed as an active, fully integrated, piezoceramic or silicon-based, sensor that operates on the basis of Coriolis forces, whereby minimum space and only a limited external circuitry on the power supply a re required.

Preferably, the measured value is filtered, via an inserted low pass filter with a critical frequency of between 10 Hz and 100 Hz, for suppression of high frequency acceleration peaks, which occur particularly in the case of percussive working of stone. An analogous low pass filter is preferably constructed using an RC combination.

Further, preferably, the measured value is filtered via an inserted high pass filter, which can be a suitably dimensioned capacitor with a downstream resistor, wherein the filter has a critical frequency of between 0.5 Hz and 10 Hz for suppression of the intentional guiding movements of the user and thus should not trigger an interruption of power.

Preferably, a weighted summation element comprising, for example, a resistance voltage distributor, is connected to an upstream integration element comprising, for example, an RC low pass filter operated above the critical frequency. Through the two time functions available at the weighted summation element—proportional to the angle of rotation and proportional to the rotational velocity—the general solution for the provisional calculation of the future angle of rotation, even in zero different constraints, is approximately realized electronically, whereby the user is allowed, within the strictly monitored limit values, an interval of rotational angle, whose starting point is preferably determined at the time of switching on the electrical drive.

Alternatively the measured value of the rotational rate sensor that has been digitized in an A/D converter is evaluated, preferably in a temporal periodic fashion or at the time of switch-on, by a microprocessor controlled in an interrupt or disconnect fashion using conventional software algorithms. Preferably, the summation element is realized by numerical addition, the integration element as an incrementally expanded sum, and the filter via weighted, incrementally sliding filled partial sums.

Preferably, the derived control signal, after comparison with a predetermined threshold value, interrupts the current path of the electrical drive via at least one of a controllable power cut-out switch and a controllable clutch unit that interrupts the power flux from the electrical drive to the tool spindle.

### BRIEF DESCRIPTION OF THE INVENTION

The invention is explained in more detail below with reference to the following drawings:

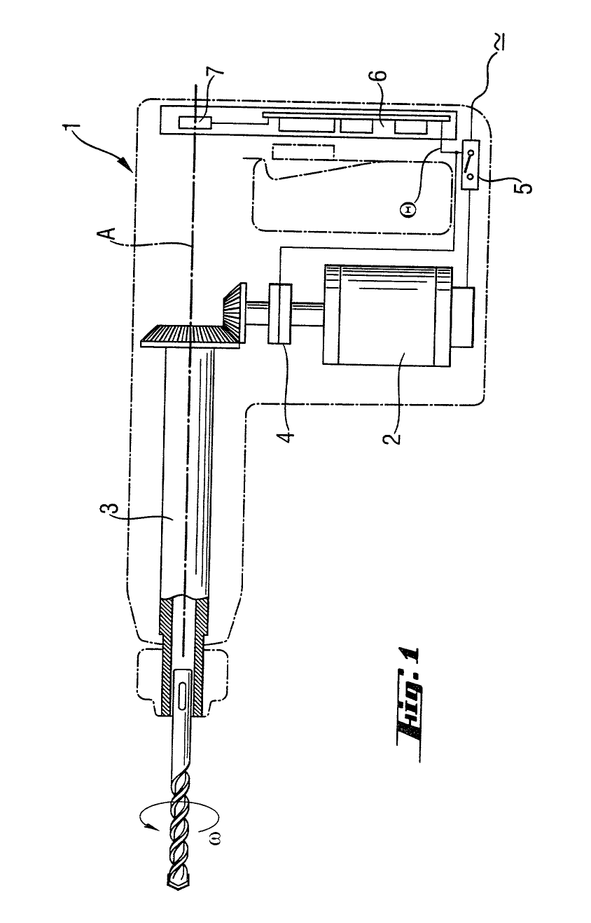

FIG. 1 shows a rotational powered hand tool with a safety switch device, in accordance with the invention;

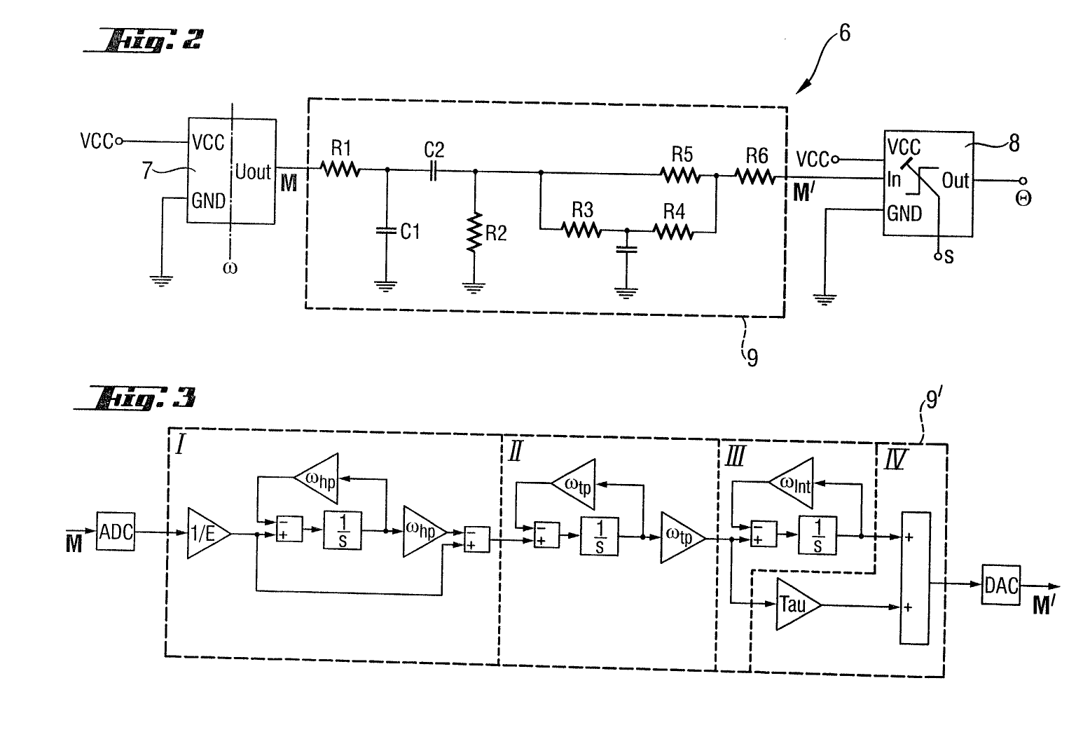

FIG. 2 shows an analogous safety switch device, in accordance with the invention; and

FIG. 3 shows a digital safety switch device, in accordance with the invention.

### DETAILED DESCRIPTION OF THE INVENTION

FIG. 1 shows an electrical power hand tool 1 rotating about an axis of rotation A comprising a controllable coupling means 4 for interruption of the power from an electrical drive 2 to a rotary tool spindle. The coupling means 4 is controllable by a control signal Θ. The electric power tool further comprises a cut-off switch 5 that is controllable by way of a control signal Θ, wherein the switch is arranged in the current path of the electrical drive 2, and an analog safety switch device 6 having a rotation rate sensor 7 that directly measures rotational velocity ω.

FIG. 2 shows a analog safety switch device, wherein the output of the rotational rate sensor 7 that measures the rotational velocity ω, is connected, in a signal transferring capacity, with a comparison element 8 executed as a comparator. The comparator compares the measured value M, which value is at least in part proportional to the rotational velocity, to a preset threshold value S. An analogously constructed functional element 9 having a temporally determined transfer function is arranged between the rotational rate sensor 7 and the comparison element 8 triggered at the time of switch-on of the electrical drive.

The components R1 and C1 form a low pass filter with the transfer function:

$${A}_{TP} ( s ) = \frac{1}{1 + {sR}_{1} {C}_{1}}$$

with s=σ+jω (complex angular frequency) and the upper critical frequency

$${f}_{k} = \frac{1}{2 π {R}_{1} {C}_{2}} of 10 Hz .$$

The components C2 and R2 form a high pass filter with the transfer function:

$${A}_{HP} ( s ) = \frac{1}{1 + \frac{1}{{sR}_{2} {C}_{2}}}$$

and the lower critical frequency

$${f}_{δ} = \frac{1}{2 π {R}_{2} {C}_{2}} of 0.5 Hz .$$

The components R3 and C3 form an integrator that is realized above its low pass filter operating at a critical frequency of 0.01 Hz. The resistors R4, R5 and R6 form in their combination an addition element, wherein R4=R5=R6 applies. In the comparison element 8, the resulting measurement signal M′ is compared to a threshold value S as the disconnect or interrupt condition. If the need arises, the drive train is interrupted.

FIG. 3 shows the digitally realized microcontroller arranged between an analog-digital converter (ADC) and a digital-analog converter (DAC) that is triggered at the time of switch-on of the electrical drive. Functional element 9′ that is realized as a software program contains, as functional supports of a digital high pass filter I, in which, previously, the input signal is normalized by way of a multiplier with 1/E, a digital low pass filter II, an integrator III and a weighted summation element IV for the weighting of the rotational velocity ω with the tau Factor. The transfer function of the functional supports are calculated in the case of the high pass filter I according to

$$\begin{matrix}{A}_{HP} ( s ) = \frac{s}{s + {ω}_{HP}} \\ {A}_{TP} ( s ) = \frac{{ω}_{TP}}{s + {ω}_{TP}}\end{matrix}$$

in the case of the low pass filter II according to and in the case of the integrator III according to

$${A}_{Int} ( s ) = \frac{1}{s + {ω}_{Int}}$$

whereby the critical frequencies are calculated from

$${f}_{x} = \frac{1}{2 π} ω ,$$

respectively. For the weighted summation element IV tau is approximately 0.02.

We hereby claim:

1. A safety switch device for the generation of a control signal (Θ) when a future angle of deflection of the housing of an at least partially rotary powered hand tool (1) is exceeded, wherein a rotational rate sensor (7) directly measuring the rotational acceleration (ω) is connected to a comparison element (8) in a signal transferring fashion.

2. The safety switch device of claim 1, wherein the rotational rate sensor (7) is an active sensor device that measures on the basis of Coriolis forces.

3. The safety switch device of claim 1, wherein a functional unit (9, 9′) is arranged in a signal transferring fashion between the rotational rate sensor (7) and the comparison element (8).

4. The safety switch device of claim 1, wherein the functional unit (9) comprises a weighted summation element (IV) having an integrator element (III) arranged upstream at one input.

5. The safety switch device of claim 1, wherein the functional unit (9) is realized without a means for integration of the rotational acceleration (ω).

6. The safety switch device of claim 1, wherein the functional unit (9) comprises a low pass filter (II) having a critical frequency between 10 and 100 Hz.

7. The safety switch device of claim 1, wherein the functional unit (9) comprises a high pass filter (I) having a critical frequency between 0.5 and 10 Hz.

8. The safety switch device of claim 1, wherein the starting point can be determined for calculation of the control signal (Θ) at the point in time of switch-on of the electrical drive (2).

9. The safety switch of claim 1, wherein the functional unit (9′) comprises a microcontroller that uses software algorithms of a microcontroller.

10. The safety switch device of claim 1, wherein at least one of a current path of an electrical drive (2) is interrupted, by a control signal (Θ), by a cut-off switch and the power flow from the electrical drive (2) to a tool spindle (3) is interrupted, and wherein the control signal (Θ) is produced by the comparison element (8) after comparison of a plurality of measured values (M, M′) to a predetermined threshold value (S).
